(19) United States
(12) Patent Application Publication
(10) Pub. No.: US 2018/0273154 A1
(43) Pub. Date: Sep. 27, 2018

(54) METHOD FOR CONFIGURING A BALLAST WATER TREATMENT SYSTEM AND RELATED SYSTEM

(71) Applicant: Bawat A/S, Denmark (DK)

(72) Inventors: John Villadsen, Ålsgårde (DK); Jan Hummer, Klampenborg (DK); Ole Lüthcke Christensen, Kgs. Lyngby (DK)

(21) Appl. No.: 15/542,345

(22) PCT Filed: Jan. 6, 2016
(86) PCT No.: PCT/EP2016/050113

§ 371 Date: Jul. 7, 2017

(30) Foreign Application Priority Data
Jan. 15, 2015 (DK) PA 2015 70020

(51) Int. Cl. B63J 4/00; C02F 1/00; G05B 19/042

(52) U.S. Cl. CPC B63J 4/002; C02F 2103/008; G05B 19/042; C02F 1/008

(57) ABSTRACT

Disclosed are a configuration system and a method for configuring a ballast water treatment system for treating ballast water of one or more ballast tanks in a vessel. The ballast water treatment system is configured to circulate ballast water between a tank outlet and a tank inlet of a first ballast tank. The method includes obtaining structural parameters of the first ballast tank. These structural parameters include a compartment number parameter indicative of a number of compartments in the first ballast tank. Control data for the ballast water treatment system based on the structural parameters is then determined. The control data includes a first volume parameter indicative of a first ballast water volume to be circulated. The control data is provided to the ballast water treatment system.

The present disclosure relates to a system and method for configuring a ballast water treatment system, such as a system for cleaning, decontaminating, sanitizing, and/or sterilizing ballast water, such as ballast water in ballast tanks onboard vessels and other offshore constructions.

### BACKGROUND

To maintain the stability of a ship independently of it carrying cargo or not, ships are provided with tanks that can be filled or emptied depending on the nature of the cargo. Such tanks are designated ballast tanks, and the water charged into these ballast water tanks is designated ballast water.

When an empty ship or a ship partially carrying cargo leaves a port, ballast water has therefore been charged into the ballast tanks to uphold stability and to adjust the buoyancy of the ship. Almost always such ballast water will contain live microorganisms, such as plankton, algae, etc. When the ship arrives at its destination, and when the ship is once again to take on a cargo, the ballast water is discharged back into the sea.

The discharge of ballast water may thus potentially introduce invasive species to the marine environment in the destination port, which means that the live microorganisms are moved from their natural habitat to a new biosphere. Those live microorganisms that are indigenous to another part of the world may be a threat to the local marine life and are therefore designated “biological pollution”. Every year, major tank vessels move billions of cubic meters of water with live microorganisms from one part of the world to another, and the tank vessels are thereby contributing factors in the introduction of hundreds of invasive marine species to new environments which is considered to be one of the world's largest environmental issues.

Now, specific requirements have been setdrawn up by the International Maritime Organization (IMO) in respect of how few live microorganisms are allowed in the discharged ballast water. The present disclosure provides means towards complying with those requirements.

### SUMMARY

There is a need for a method and/or a system which provides ways for configuring a ballast water treatment system to be effective and reliable in handling and/or treating ballast water, thereby reducing the risk of biological pollution.

Accordingly, a method for configuring and/or controlling a ballast water treatment system is provided. In particular for configuring and/or controlling a ballast water treatment system for treating ballast water of one or more ballast tanks in a vessel, wherein the ballast water treatment system is configured to circulate ballast water between a tank outlet and a tank inlet of a first ballast tank. The method comprises obtaining structural parameters of the first ballast tank, wherein the structural parameters comprise a compartment number parameter indicative of a number of compartments in the first ballast tank. The method further comprises determining control data for the ballast water treatment system based on the structural parameters, wherein the control data comprises a first volume parameter indicative of a first ballast water volume to be circulated. The method further comprises providing the control data to the ballast water treatment system and/or controlling the ballast water treatment system based on the control data.

Also disclosed is a configuration system for configuring a ballast water treatment system. In particular for configuring a ballast water treatment system for treating ballast water of one or more ballast tanks in a vessel, wherein the ballast water treatment system is configured to circulate ballast water between a tank outlet and a tank inlet of a first ballast tank. The configuration system comprises a processing unit, an interface, and a memory unit. The processing unit and/or the configuration system is configured to: obtain structural parameters of the first ballast tank, wherein the structural parameters comprise a compartment number parameter indicative of a number of compartments in the first ballast tank; determine control data for the ballast water treatment system based on the structural parameters, wherein the control data comprises a first volume parameter indicative of a first ballast water volume to be circulated; and provide the control data, such as provide the control data to the ballast water treatment system, the interface, and/or the memory unit.

Ballast water must be treated such that the content of living microorganisms per volume is less than a threshold value, such as set by authorities. The present disclosure provides control parameters and control systems in order to ensure that these requirements are met.

The disclosed system and method provides means for configuring a ballast water treatment system to control the treatment of ballast water according to easily accessible parameters. For example, the treatment of ballast water may be controlled using parameters such as pumped/circulated volume and/or gas content, such as oxygen content and/or carbon dioxide content, in the ballast water.

It is an advantage of the present disclosure that easily accessible parameters, such as structural parameters of the ballast tank, such as the first ballast tank, may be used to configure the ballast water treatment system. For example, the structural parameters may be used to predict the treatment necessary to reduce living microorganisms in the ballast water to a certain threshold. Allowing such configuration to be performed from easily accessible parameters, treatment systems may be configured and/or dimensioned easier leading to reduced time and costs.

It is a further advantage of the present disclosure that it reduces the need for experiments to find the optimal configuration and/or design of a ballast water treatment system. Thereby leading to a more precise and cost efficient way of configuration and/or design of a ballast water treatment system.

It is a further advantage of the present disclosure that an effective and reliable system for treating ballast water may systematically be dimensioned. The disclosure provides ways which will provide for ease of dimensioning a ballast water treatment system.

It is a further advantage of the present disclosure that it provides configuration of a ballast water treatment system which reduces the risk of excess treatment, leading to reduced and optimized energy consumption, e.g. reducing energy consumption when specific parameters have been met.

It is a further advantage of the present disclosure that a system for treating ballast water may conveniently be dimensioned to an existing ballast tank or ballast tanks, e.g. the system may easily be retrofitted to an existing ballast tank.

### BRIEF DESCRIPTION OF THE DRAWINGS

The above and other features and advantages of the present invention will become readily apparent to those skilled in the art by the following detailed description of exemplary embodiments thereof with reference to the attached drawings, in which:

FIG. 1 schematically illustrates an exemplary ballast water system,

FIG. 2 schematically illustrates an exemplary ballast water treatment system,

FIG. 3 is a flow chart of a method for configuring a ballast water treatment system,

FIG. 4 is a flow chart of a method for controlling a ballast water treatment system,

FIG. 5 schematically illustrates an exemplary determinator, and

FIG. 6 schematically illustrates an exemplary configuration system.

### DETAILED DESCRIPTION

The structural parameters may comprise a first structural parameter, a second structural parameter, a third structural parameter, and/or a fourth structural parameter.

A ship or vessel may comprise a plurality of ballast tanks, e.g. including the first ballast tank and a second ballast tank. A ballast tank, such as the first ballast tank and/or the second ballast tank, may be a ballast tank of a plurality of ballast tanks.

The ballast water treatment system for treating ballast water may be a ballast water treatment system for treating ballast water of one or more ballast tanks in a vessel, such as for treating ballast water of a ballast tank, such as a first ballast tank and/or a second tank.

The structural parameters comprise a compartment number parameter. The compartment number parameter may be the first structural parameter. The first structural parameter and/or the compartment number parameter may be indicative of a number of compartments in the first ballast tank.

The structural parameters may comprise compartment size parameters. The compartment size parameters may be the second structural parameter. The second structural parameter and/or the compartment size parameters may be indicative of size, such as volume and/or relative volume, of compartments in the first ballast tank.

The structural parameters may comprise a first compartment size parameter indicative of size of a first compartment of the first ballast tank. The structural parameters may comprise a second compartment size parameter indicative of size, such as volume and/or relative volume, of a second compartment of the first ballast tank. The structural parameters may comprise a plurality of compartment size parameters indicative of size, such as volume and/or relative volume, of a respective plurality of compartments of the first ballast tank. The plurality of compartment size parameters may comprise the first compartment size parameter and the second compartment size parameter. A compartment size parameter, such as the first compartment size parameter and/or the second compartment size parameter, may be indicative of compartment size or compartment size relative to a total size, such as volume, of all compartments in the first ballast tank, e.g. the total size of all compartments filled with ballast water in the first ballast tank.

The structural parameters may comprise ballast water level parameters. The ballast water level parameters may be the third structural parameter. The third structural parameter and/or the ballast water level parameters may be indicative of ballast water levels in the first ballast tank.

The structural parameters may comprise a first ballast water level parameter indicative of a first ballast water level in the first ballast tank, e.g. in order to determine the number of active compartments The structural parameters may comprise a second ballast water level parameter indicative of a second ballast water level in the first ballast tank. The structural parameters may comprise a plurality of ballast water level parameters indicative of a respective plurality of ballast water levels in the first ballast tank. The plurality of ballast water level parameters may comprise the first ballast water level parameter and the second ballast water level parameter.

The structural parameters may comprise compartment wall parameters. The compartment wall parameters may be the fourth structural parameter. The fourth structural parameter and/or the compartment wall parameters may be indicative of the area of compartment wall openings between adjacent compartments in the first ballast tank.

The structural parameters may comprise a first compartment wall parameter indicative of the area of compartment wall openings between a first compartment and a second compartment of the first ballast tank. The structural parameters may comprise a second compartment wall parameter indicative of the area of compartment wall openings between the second compartment and a third compartment of the first ballast tank. The structural parameters may comprise one or more compartment wall parameters indicative of the area of compartment wall openings between adjacent compartments. The one or more compartment wall parameters may comprise the first compartment wall parameter and the second compartment wall parameter.

A compartment wall parameter, such as the first compartment wall parameter and/or the second compartment wall parameter, may be indicative of the area of compartment wall openings relative to a compartment wall having no openings, such as a compartment wall completely separating the ballast water of the two adjacent compartments.

The compartment number parameter is indicative of the number of compartments in the first ballast tank, such as a total number of compartments in the first ballast tank and/or a number of compartments filled with water. The compartment number parameter may be indicative of a total number of compartments in the first ballast tank. Alternatively or additionally, the compartment number parameter may be indicative of a number of compartments filled with ballast water, e.g. the compartment number parameter may be indicative of the number of compartments filled with water at a ballast water level, such as the first ballast water level and/or the second ballast water level. Compartments filled with ballast water may be denoted as ‘active’ compartments.

The compartment number parameter may be dependent on one or more of the compartment wall parameters. A compartment wall parameter may define two compartments if the compartment wall parameter is indicative of an area of compartment wall opening less than a threshold. For example, two compartments may for example be counted as two compartments if the area of compartment wall openings between the two compartments is less than 40%, such as less than 30%, such as less than 20%, such as less than 10%. Alternatively or additionally, the two compartments may for example be counted or regarded as one compartment if the area of compartment wall openings between the two compartments is more than 90%, such as more than 80%, such as more than 70%, such as more than 60%.

One or more of the structural parameters may be obtained from user input and/or by electronic transmission, e.g. transmitting the structural parameters from a database system and/or a computer system, such as a ship computing system. Obtaining one or more of the structural parameters may comprise receiving a user input comprising one or more of the structural parameters, and/or obtaining one or more of the structural parameters may comprise requesting the one or more structural parameters from a database system and/or a computer system.

The control data comprises a first volume parameter indicative of a first ballast water volume to be circulated. The first ballast water volume may be ballast water volume to be circulated at a first ballast water level. The first volume parameter may be indicative of a first ballast water volume to be circulated at a first ballast water level.

The control data may comprise a second volume parameter indicative of a second ballast water volume to be circulated. The second ballast water volume may be ballast water volume to be circulated at a second ballast water level. The second volume parameter may be indicative of a second ballast water volume to be circulated at a second ballast water level.

The control data may comprise a plurality of volume parameters indicative of a plurality of ballast water volumes to be circulated, e.g. indicative of a plurality of ballast water volumes to be circulated for a plurality of configurations, such as a plurality of ballast water levels. The plurality of ballast water volumes may be ballast water volumes to be circulated at a plurality of respective ballast water levels. The plurality of volume parameters may comprise the first volume parameter and the second volume parameter.

A volume parameter, such as the first volume parameter, and/or the second volume parameter, may be a multiplication factor of volume of ballast water in the first ballast tank. For example, the volume of ballast water in the first ballast tank may be 200 m³ and the ballast water volume to be circulated may be 4 times the volume of ballast water in the first ballast tank, i.e. 800 m³. For computational reasons, it may be an advantage to express the volume parameter as a multiplication factor of volume of ballast water. A safety margin, such as in the range from 20 to 50%, e.g. about 33%, may be applied to a volume parameter, such as the first volume parameter, and/or the second volume parameter.

As previously described, treatment of ballast water may be required to ensure that the ballast water in a ballast tank, such as the first ballast tank, does not contain living microorganisms, or that the concentration of living microorganisms in the ballast water is below a given threshold. Such threshold may be set in requirements set by governments or intergovernmental organizations, such as the International Maritime Organization.

It may be difficult to measure the actual concentration of living microorganisms in the ballast water in a ballast tank. Therefore, it may be beneficial to instead treat the ballast water to attain a certain reduction of living microorganism relative to the concentration of living microorganisms in the ballast water before starting the treatment. Such reduction may be indicated by a reduction parameter having a required reduction value. For example, such a reduction parameter may be given as a relative concentration, for example,

$$x = \frac{c}{{c}_{t = 0}}$$

where c is the concentration of living microorganisms, and cₜ₌₀ is the concentration of microorganisms at time t=0, for example before starting the treatment.

To comply with requirements, a desired reduction of concentration of living microorganisms in the ballast water may for example be 90%, 99%, 99.9% or 99.99%. The desired reduction may be dependent on the concentration of living microorganisms before treatment, e.g. at time t=0. The desired reduction may be dependent on the concentration of living microorganisms before treatment. For example, if the concentration of living microorganisms in the ballast water before treatment is very small, the desired or needed reduction may be very small, e.g. <50%. On the contrary, if the concentration of living microorganisms in the ballast water before treatment is very high, the desired or needed reduction may be very high, e.g. >99.9%.

The concentration of living microorganisms before treatment may be measured, e.g. by measuring the concentration of living microorganisms in the ballast water entering into the ballast tank, such as the first ballast tank. Alternatively or additionally, the concentration of living microorganisms before treatment may be estimated, e.g. by assuming a worst case scenario, based on known ballast water properties (seasonal, temperature, salinity) and/or based on a scenario dependent on the geographical location of taking up the ballast water.

The method may comprise obtaining a reduction parameter indicative of a desired reduction of concentration of living microorganisms in the ballast water, such as the reduction parameter as described above. The configuration system and/or the processing unit of the configuration system may be configured to obtain a reduction parameter indicative of a desired reduction of concentration of living microorganisms in the ballast water, such as the reduction parameter as described above.

Obtaining the reduction parameter and/or the method may comprise obtaining concentration of living microorganisms in the ballast water in the first ballast tank. For example, obtaining the reduction parameter and/or the method may comprise obtaining a concentration of living microorganisms in the ballast water before treatment, e.g. by measuring the concentration of living microorganisms in the ballast water entering the ballast tank, such as the first ballast tank. Alternatively and/or additionally, obtaining the reduction parameter and/or the method may comprise obtaining a geographical parameter indicative of a geographical location of taking up the ballast water.

Determining the control data may be based on the reduction parameter. For example, the reduction parameter may indicate the necessary treatment. Therefore, treating based on a reduction parameter may save power consumption, as treatment may be terminated or decreased when a desired reduction indicated by the reduction parameter is met.

Determining the control data may comprise solving one or more sets of differential equations. The one or more sets of differential equations may be based on the structural parameters. Additionally or alternatively, the set of differential equations may be based on the reduction parameter and/or concentration parameters indicative of concentrations of living microorganisms in the ballast water.

The geometric design of ballast tank Tₖ is typically such that the tank volume Vₖ can be regarded as M serially connected compartments Cᵢ with different volumes Vᵢ (m³). Vₖ=Σ₁^{M}Vᵢ.

The one or more sets of differential equations may model the change in concentration of living microorganisms in ballast tank compartments.

For a simple tank configuration with a single section, a single set of differential equations may model the change in concentration of living microorganisms in (active) ballast tank compartments Cᵢ, i=1, . . . , M relative to initial concentrations of living microorganisms in ballast tank compartments. The set of differential equations may comprise a series of M coupled differential equations. The single (first) set of differential equations may be given by:

$$\frac{{dx}_{i}}{d Φ} = ( {x}_{( i - 1 )} - {x}_{i} ) for i = 1 , … , M ,$$

where:

$${x}_{i} = \frac{{c}_{i}}{{c}_{i , t = 0}} ,$$

is relative reduction of concentration of living microorganisms in compartment Cᵢ, where cᵢ is the concentration of living microorganisms in compartment Cᵢ, and c_{i,t=0} is the concentration of microorganisms in compartment Cᵢ at time t=0, for example before starting the treatment. The initial concentration of living microorganisms in all compartments Cᵢ, i=1, . . . , M may be assumed to be the same cₜ₌₀.

M is the number of (active) compartments in the tank or a section of the tank.

$${x}_{0} = \frac{{c}_{0}}{{c}_{0 , t = 0}} ,$$

is relative concentration of living microorganisms in ballast water entering through the tank inlet, where c₀ is the concentration of living microorganisms in ballast water entering through the tank inlet, and c_{0,t=0} is the concentration of living microorganisms in ballast water entering through the tank inlet at time t=0.

$$Φ = \frac{{v}_{l} t}{{V}_{i}} ,$$

is a dimensionless time of operation, wherein vₗ is the flow rate of ballast water through the ballast tank, e.g. at tank inlet/outlet, t is the time, e.g. the time of operation, and Vᵢ is the volume of water in compartment Cᵢ. Vᵢ may be given by a fraction αᵢ of a volume of ballast water in the ballast tank.

t=0 may be the time of starting the treatment. It may be assumed that the ballast water pumped into the ballast tanks comprises a homogenous, or nearly homogenous, concentration of living microorganisms. Hence, it may be assumed that the relative concentration of living microorganisms in compartment Cᵢ is xᵢ=1 at time t=0.

Time, t may e.g. be in units of hours, Vᵢ may be in units of m³, vₗ may be in units of m³/hour.

c₀ is the concentration of living microorganisms in ballast water entering through the tank inlet. The water treatment system is designed such that the concentration of living microorganisms in the ballast water entering the tank inlet is reduced to nearly zero. Thus, the concentration c₀ of living microorganisms in ballast water entering through the tank inlet may be zero or close to zero due to the treatment of ballast water in the water treatment unit. Accordingly, the relative concentration x₀ of living microorganisms in ballast water entering through the tank inlet may for all practical purposes be set to zero, or close to zero (e.g. 10⁻⁴ or 10⁻⁶). Therefore it may be assumed that the concentration of living microorganisms in the ballast water entering the tank inlet c₀≅0 for t>0. Following, it may be assumed that x₀≅0 for t>0.

Concentration of living microorganisms in compartment C₁, e.g. the first compartment C₁, denoting the compartment wherein ballast water from the tank inlet is entering, is the first to reach a very low concentration, and the value of x₁→0. The concentration x_{M} in compartment C_{M}, denoting the compartment furthest from where the ballast water enters the tank will be the last to reach the desired reduction. The concentration of living microorganisms in compartment C_{M} may therefore be used to determine a time/value for which a parameter, e.g. the reduction parameter, has been achieved. The relative concentration x_{M} of living microorganisms in compartment C_{M} which is furthest from the entry to the ballast tank will decrease towards zero. The relative concentration x_{M} of living microorganisms in compartment C_{M} will reach the required reduction value (e.g. 10⁻⁴) at ϕ=ϕₜₒₜₐₗ, where ϕₜₒₜₐₗ is indicative of the number of times which the ballast water volume Vₖ is to be circulated.

For an exemplary tank configuration with four (active) compartments C₁, C₂, C₃, C₄ of equal size, ϕₜₒₜₐₗ is in the range of 3-4 with a required reduction value of 10⁻⁴. Thus for such a configuration, the first volume parameter may be set to the value of ϕₜₒₜₐₗ, optionally in addition including a safety margin.

The model assumes that the ballast water in each compartment is homogeneously mixed, e.g. that concentration of living microorganisms is the same throughout the compartment. Such mixing may be achieved in various ways, for example, by sparging with gas, such as nitrogen or atmospheric air, e.g. together with the ballast water entering through the inlet. Alternatively or additionally, a mixer unit, such as a turbine, may be installed in each compartment.

The above may be generalized to a ballast tank comprising J parallel sections Sⱼ, j=1, . . . , J, and wherein a section Sⱼ comprises Mⱼ serially connected compartments with volume V_{i,j} with separate flow v_{l,j} in each section Sⱼ, j=1, . . . , J. Typically, the number J of sections in a ballast tank may be from 2 to 40.

The above may be generalized to N ballast tanks T₁, . . . , T_{N}, wherein a ballast tank Tₖ comprises J sections Sⱼ, j=1, . . . , J, and wherein a section Sⱼ comprises Mⱼ serially connected compartments. Typically, the number N of ballast tanks on a vessel is from 2 to 16.

The total volume V of ballast water may be distributed between N ballast tanks. The ballast tanks may hold different volumes Vₖ of ballast water. A limited volume Vₚ of ballast water may be located outside the ballast tanks, e.g. in a ballast water treatment system and/or in pipe structures. However, typically this volume Vₚ is much smaller than V or Vₖ, and therefore V≅Σₖ₌₁^{N}Vₖ.

The total ballast tank capacity may be V_{T}, and the total capacity of ballast tank Tₖ may be Vₖ, i.e. V_{T}=Σₖ₌₁^{N}Vₖ. The N ballast tanks may not be completely filled with ballast water, i.e. V≤V_{T}.

A ballast tank Tₖ may be divided into J sections Sⱼ, j=1, . . . , J. The volume Vₖ of ballast water in ballast tank Tₖ may be distributed between the J sections holding a volume V_{j,k} of ballast water. Thus, Vₖ=Σⱼ₌₁^{J}V_{j,k}.

A section Sⱼ may be divided into Mⱼ compartments C_{i,j}, i=1, . . . , Mⱼ. The volume of ballast water V_{j,k} in section Sⱼ of ballast tank k may be distributed between the Mⱼ compartments holding a volume V_{i,j,k} of ballast water. Thus, V_{j,k}=Σᵢ₌₁^{M}V_{i,j,k}.

For a given ballast tank with J sections, each section Sⱼ having Mⱼ compartments, the set of differential equations may be given by J sets of differential equations:

$$\frac{{dx}_{i , j}}{d {Φ}_{j}} = ( {x}_{( i - 1 ) , j} - {x}_{i , j} )$$

$$for i = 1 , … , {M}_{j} and j = 1 , … , J ,$$

where:

$${x}_{i , j} = \frac{{c}_{i , j}}{{c}_{i , j , t = 0}} ,$$

is relative reduction of concentration of living microorganisms in compartment C_{i,j} of section Sⱼ of the ballast tank, where c_{i,j} is the concentration of living microorganisms in compartment C_{i,j} of section Sⱼ, and c_{i,j,t=0} is the concentration of microorganisms in compartment C_{i,j} of section Sⱼ at time t=0, for example before starting the treatment. The initial concentration of living microorganisms in all compartments Cᵢ, i=1, . . . , Mⱼ may be assumed to be the same cₜ₌₀.

Mⱼ is the number of (active) compartments of section Sⱼ.

$${x}_{0 , j} = \frac{{c}_{0 , j}}{{c}_{0 , j , t = 0}} ,$$

is relative concentration of living microorganisms in ballast water entering through the tank inlet of section Sⱼ, where c_{0,j} is the concentration of living microorganisms in ballast water entering through the tank inlet of section Sⱼ, and c_{0,j,t=0} is the concentration of living microorganisms in ballast water entering through the tank inlet of section Sⱼ at time t=0.

$${Φ}_{j} = \frac{{v}_{l , j} t}{{v}_{i , j}} ,$$

is a dimensionless time of operation, wherein v_{l,j} is the flow rate with which ballast water is entering through the tank inlet of section Sⱼ, t is the time, e.g. the time of operation, and V_{i,j} is the volume of water in compartment C_{i,j} of section Sⱼ. V_{i,j} may be given by a fraction α_{i,j} of a volume of ballast water in the j'th section and/or in the ballast tank.

t=0 may be the time of starting the treatment. It may be assumed that the ballast water pumped into the ballast tanks comprise a homogenous, or nearly homogenous, concentration of living microorganisms. Hence, it may be assumed that the relative concentration of living microorganisms in the ballast water in compartment C_{i,j} of section Sⱼ is x_{i,j}=1 at time t=0.

Time, t may e.g. be in units of hours, V_{i,j} may be in units of m³, v_{l,j} may be in units of m³/hour.

The treatment system may be designed such that the concentration of living microorganisms in the ballast water entering the tank inlet of the j'th section is reduced to nearly zero. Therefore it may be assumed that the concentration of living microorganisms in the ballast water entering the tank inlet c_{0,j}≅0 for t>0. Following, it may be assumed that x_{0,j}≅0 for t>0.

The relative concentration x_{M,j} of living microorganisms in compartment C_{M,j} which is furthest from the entry to the j'th section of the ballast tank will decrease towards zero. The relative concentration x_{M,j} of living microorganisms in compartment C_{M,j} will reach the required reduction value (e.g. 10⁻⁴) at ϕⱼ=ϕ_{total,j}, where ϕ_{total,j} is indicative of the number of times which the ballast water volume Vⱼ=Σᵢ₌₁^{M}V_{i,j} of the j'th section is to be circulated.

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

Throughout, the same reference numerals are used for identical or corresponding parts.

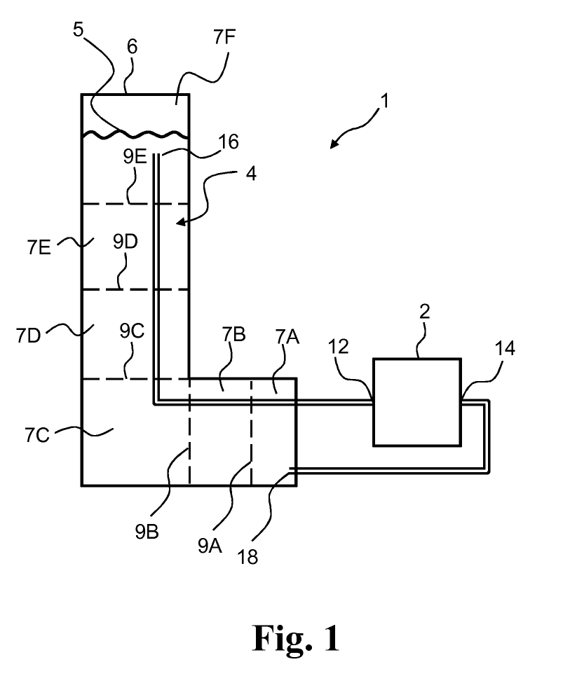

FIG. 1 schematically illustrates an exemplary ballast water system 1. The ballast water system 1 comprises a ballast water treatment system 2 and a ballast tank 6. The ballast water treatment system 2 may be a circulation system.

The ballast tank 6 has a tank inlet 18 and a tank outlet 16. The tank inlet 18 is positioned below the tank outlet 16, e.g. tank inlet 18 may be at the lower part of the ballast tank 6, and/or the tank outlet 16 may be at the upper part of the ballast tank 6. The tank outlet 16 may be configured to effectively be in the vicinity of the surface of the ballast water 4, e.g. below and near a ballast water level 5. For example, the tank outlet 16 may have a plurality of vertically distributed openings (not shown) inside the ballast tank 6 for facilitating suction of ballast water at different ballast water levels 5 in the ballast tank.

The ballast water treatment system 2 is connected to the ballast tank 6. The ballast water treatment system 2 is configured to circulate and/or treat, e.g. pasteurize, ballast water 4 between the tank outlet 16 and the tank inlet 18. The ballast water 4 at least partly fills the ballast tank 6, e.g. to the ballast water level 5. The ballast water treatment system 2 comprises a first system inlet 12 and a first system outlet 14. The first system inlet 12 is coupled to the tank outlet 16 and the first system outlet 14 is coupled to the tank inlet 18.

In FIG. 1 the ballast water treatment system 2 is depicted and described as being configured to circulate ballast water 4 of the ballast tank 6. However, the ballast water treatment system 2 may be configured to circulate ballast water 4 of one or more ballast tanks, e.g. including the ballast tank 6.

The ballast tank 6 may comprise one or more sections. FIG. 1 illustrates a first section of the ballast tank 6, the first section comprising a plurality of compartments (e.g. five or more) 7A, 7B, 7C, 7D, 7E, 7F, separated by respective compartment walls 9A, 9B, 9C, 9D, 9E. Ballast tanks such as the ballast tank 6 may be L-shaped, as depicted, or alternatively, the ballast tank may be I-shaped or U-shaped or other complex shape.

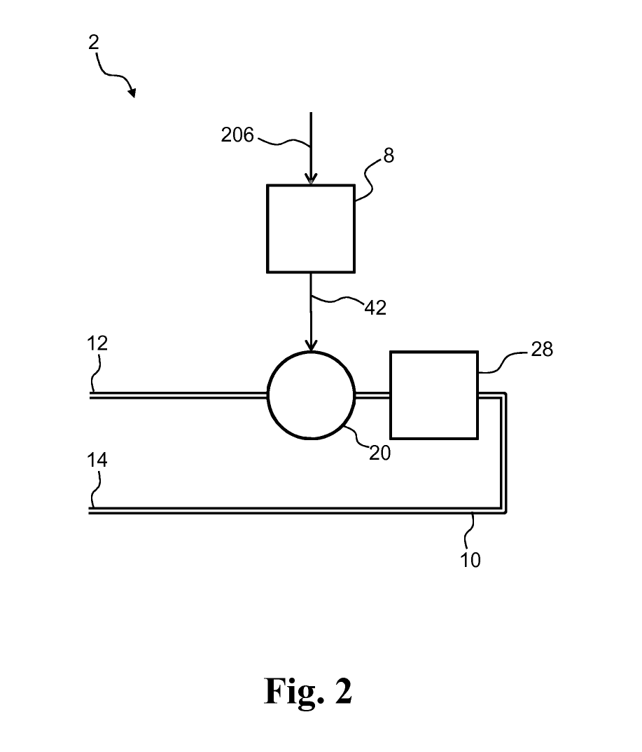

FIG. 2 schematically illustrates an exemplary ballast water treatment system 2 for circulating ballast water, e.g. ballast water of one or more ballast tanks, as illustrated and described in relation to FIG. 1.

The ballast water treatment system 2 comprises a control unit 8, a pipe structure 10, a pump unit 20, and a water treatment unit 28.

The pipe structure 10 has a first system inlet 12 and a first system outlet 14. The first system inlet 12 is configured for fluid communication with a tank outlet of a ballast tank, such as the first ballast tank, and the first system inlet 12 is configured for supplying ballast water to the ballast water treatment system 2. The first system outlet 14 is configured for fluid communication with a tank inlet of the one or more ballast tanks, such as the first ballast tank, and the first system outlet 14 is configured for supplying ballast water to the one or more ballast tanks.

The pump unit 20, e.g. a circulation pump, is configured for circulating ballast water between the first system inlet 12 and the first system outlet 14, such as between a tank outlet and a tank inlet, such as between a tank outlet and a tank inlet of the first ballast tank. The pump unit is connected to the control unit 8. The pump unit 20 may be configured to pump up to 500 m3 ballast water per hour or more.

The control unit 8 may be configured to obtain a circulated volume parameter indicative of circulated volume. For example, the control unit 8 may be configured to estimate circulated volume from duration of operation of the ballast water treatment system 2 and/or duration of operation of the pump unit 20 and/or pump speed of the pump unit 20. Alternatively or additionally, the ballast water treatment system 2 may comprise a sensor unit (not shown), and the control unit 8 may obtain the circulated volume parameter based on a sensor output.

The control unit 8 may be configured to receive control data 206. For example, the control data 206 may be received from an operator providing the control data via a user interface, or the control data 206 may be received from a configuration system.

In the depicted example, the control unit 8 receives the control data 206. However, alternatively or additionally, the control unit 8 may determine the control data 206 based on structural parameters. The control unit 8 may be configured to receive and/or obtain the structural parameters.

The control unit 8 may be configured to control the ballast water treatment system 2 based on the control data 206. The control data 206 may comprise a volume parameter, such as a first volume parameter indicative of a first ballast water volume to be circulated.

The control unit 8 may be configured to determine if a pump criterion is fulfilled. The pump criterion may be based on the circulated volume parameter obtained. For example, the pump criterion may comprise comparing circulated volume and a threshold value, such as a volume parameter of the control data 206, such as the first volume parameter.

The threshold value and/or the first volume parameter may be a function, such as a multiplication, of ballast water volume in the one or more ballast tanks. For example, the threshold value may be between 1 and 10 times the ballast water volume in the one or more ballast tanks, e.g. 6 times the ballast water volume in the one or more ballast tanks.

The control unit 8 is further configured to operate the pump unit 20. The control unit 8 is configured to operate the pump unit 20 based on whether the pump criterion is fulfilled or not and/or based on the control data 206. For example, the control unit 8 may be configured to reduce pump speed of the pump unit 20 if the pump criterion or a sub criterion thereof is fulfilled, e.g. the control unit 8 may be configured to reduce flow through the pipe structure 10 if the pump criterion is fulfilled. Alternatively or additionally, the control unit 8 may be configured to increase pump speed and/or maintain pump speed if the pump criterion is not fulfilled. The control unit 8 transmits a pump control signal 42 to the pump unit 20. The pump unit 20 is configured to receive the pump control signal 42 and operate accordingly. For example, the pump control signal 42 may be indicative of pump speed, and the pump unit 20 may adjust pump speed in accordance with pump speed indicated by the pump control signal 42.

The water treatment unit 28 treats ballast water between the first system inlet 12 and the first system outlet 14. The water treatment unit 28 is configured to reduce or eliminate living microorganisms in the ballast water. For example, the water treatment unit 28 may add chemicals to the ballast water. Additionally or alternatively, the water treatment unit 28 may provide heat treatment of the ballast water, such as a pasteurization of the ballast water. Additionally or alternatively, the water treatment unit 28 may add a gas and/or a liquid and/or a combination of a gas and a liquid to the ballast water. For example, addition of gas, such as nitrogen, may facilitate depletion of oxygen in the ballast water. Addition of a gas, such as nitrogen, may aid to stirring or mixing the ballast water in the one or more ballast tanks and/or in the compartments of the one or more ballast tanks. Thereby, the ballast water is homogenous, or roughly homogenous, in the one or more ballast tanks and/or in each compartment of the one or more ballast tanks.

FIG. 3 is a flow chart of an exemplary method 100 for configuring a ballast water treatment system. The ballast water treatment system is configured for treating ballast water of one or more ballast tanks in a vessel, such as a ballast water treatment system 2 as illustrated in FIG. 1 and FIG. 2. The ballast water treatment system is further configured to circulate ballast water between a tank outlet and a tank inlet of a first ballast tank, such as a ballast tank 6 as illustrated in FIG. 1.

The method 100 comprises obtaining 102 structural parameters of the first ballast tank, determining 104 control data based on the structural parameters, and providing 106 the control data.

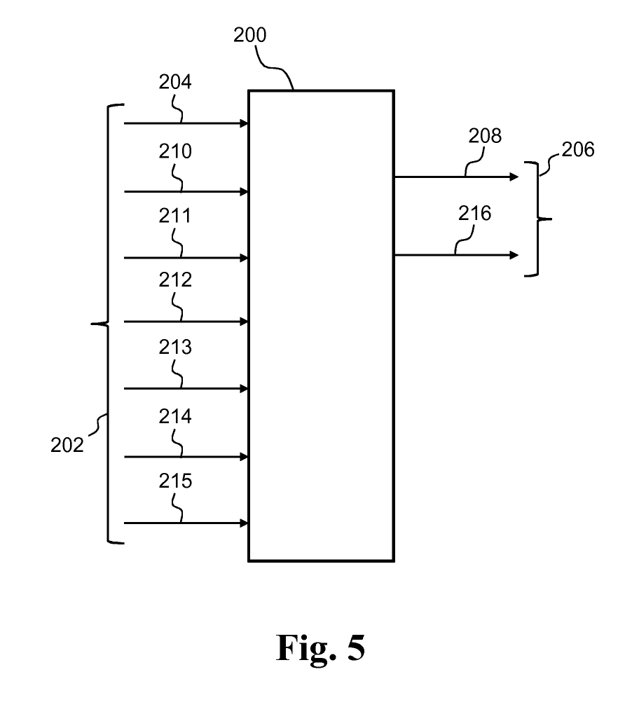

The structural parameters of the first ballast tank comprise a compartment number parameter indicative of a number of compartments in the first ballast tank. The number of compartments may be a total number of compartments in the first ballast tank, and/or it may be a number of (active) compartments below a ballast water level, e.g. a first ballast water level, in the first ballast tank. The structural parameters may optionally comprise additional structural parameters as described in relation to FIG. 5.

Obtaining 102 structural parameters may comprise receiving a user input comprising the structural parameters and/or obtaining 102 structural parameters may comprise requesting the structural parameters from a database system and/or a computer system.

The control data comprises a first volume parameter indicative of a first ballast water volume to be circulated. The first volume parameter may be indicative of a first ballast water volume to be circulated at a given water level, e.g. the first water level. The control data may optionally comprise additional parameters as described in relation to FIG. 5.

Determining 104 the control data may be based on solving, such as numerically solving, a one or more sets of differential equations based on the structural parameters.

For example, the set of differential equations may model the change and/or reduction in concentration of living microorganisms in (active) compartments Cᵢ, i=1, . . . , M of the first ballast tank. For example, the (first) set of differential equations may be given by:

$$\frac{{dx}_{i}}{d Φ} = ( {x}_{i - 1} - {x}_{i} ) for i = 1 , … , M ,$$

where:

$${x}_{i} = \frac{{c}_{i}}{{c}_{i , t = 0}} ,$$

is relative reduction of concentration of living microorganisms in compartment Cᵢ, where cᵢ is the concentration of living microorganisms in compartment Cᵢ, and c_{i,t=0} is the concentration of microorganisms in compartment Cᵢ at time t=0, for example before starting the treatment. The initial concentration c_{i,t=0} of microorganisms in compartment Cᵢ at time t=0 may be assumed to be the same cₜ₌₀.

$${x}_{0} = \frac{{c}_{0}}{{c}_{0 , t = 0}} ,$$

is relative concentration of living microorganisms in ballast water entering through the tank inlet, where c₀ is the concentration of living microorganisms in ballast water entering through the tank inlet, and c_{0,t=0} is the concentration of living microorganisms in ballast water entering through the tank inlet at time t=0.

$$Φ = \frac{{v}_{l} t}{{V}_{i}} ,$$

is a dimensionless time of operation, wherein vₗ is the flow rate of ballast water through the ballast tank, t is the time, e.g. the time of operation, and Vᵢ is the volume of water in compartment Cᵢ. Vᵢ may be given by a fraction αᵢ of a volume of ballast water in a given section of the first ballast tank or in the first ballast tank.

t=0 is the time of starting the treatment. It may be assumed that the ballast water pumped into the ballast tanks comprise a homogenous, or nearly homogenous, concentration of living microorganisms. Hence, it may be assumed that the relative concentration of living microorganisms in compartment Cᵢ is xᵢ=1 at time t=0.

M is the number of (active) compartments in the first ballast tank or a section of the first ballast tank. Typically, the number of compartments M is in the range from 2 to 10.

Determining 104 the control data may comprise determining the value of Φ wherein a reduction parameter has been achieved. For example, the value of Φ may be determined for x_{M}, i.e. the last compartment, reaching a required reduction value (e.g. 10⁻⁴). The required reduction value may be based on a worst case scenario of initial concentration of living microorganisms cₜ₌₀ in the ballast water, and a desired concentration of living microorganisms in the ballast water. Alternatively, the reduction value may be based on a measured initial concentration of living microorganisms cₜ₌₀ in the ballast water and the desired concentration of living microorganisms in the ballast water.

Providing 106 the control data may comprise providing the control data to the ballast water treatment system, such as providing the control data to a control system of the ballast water treatment system as further described in relation to FIG. 2.

Providing 106 the control data may comprise that an operator provides the control data via a user interface to ballast water system. Alternatively or additionally, the control data may be provided 106 to the ballast water system via an interface, such as a USB port, a network interface, bluetooth, etc.

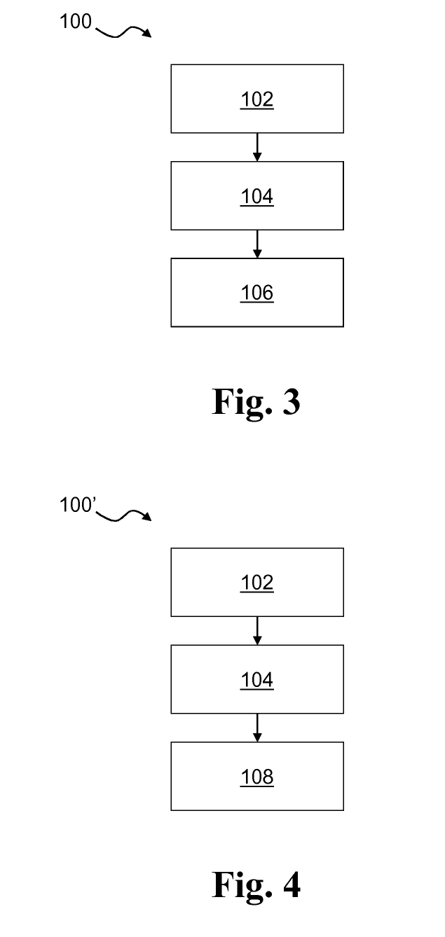

FIG. 4 is a flow chart of an exemplary method 100′ for controlling a ballast water treatment system. The ballast water treatment system is configured for treating ballast water of one or more ballast tanks in a vessel, such as a ballast water treatment system 2 as illustrated in FIG. 1 and FIG. 2. The ballast water treatment system is configured to circulate ballast water between a tank outlet and a tank inlet of a first ballast tank, such as a ballast tank 6 as illustrated in FIG. 1.

The method 100′ comprises obtaining 102 structural parameters of the first ballast tank, determining 104 control data based on the structural parameters, and controlling 108 the ballast water treatment system based on the control data.

Obtaining 102 structural parameters and determining 104 control data is described in relation to FIG. 3.

The control data may comprise a volume parameter, such as a first volume parameter indicative of a first ballast water volume to be circulated. Controlling 108 the ballast water treatment system may comprise determining if a pump criterion is fulfilled. For example, the pump criterion may comprise comparing a circulated volume and a volume parameter of the control data, such as the first volume parameter.

FIG. 5 schematically illustrates an exemplary determiniator 200. The exemplary determiniator 200 illustrates the determining step 104 of the method 100 for configuring a ballast water treatment system as described in relation to FIG. 3, and/or the method 100′ for operating a ballast water treatment system as described in relation to FIG. 4.

The determiniator 200 obtain and/or receive structural parameters 202 of a first ballast tank, and the determinator 200 provides control data 206.

The structural parameters 202 comprise a first structural parameter, such as a compartment number parameter 204. The structural parameters 202 optionally comprise a second structural parameter, such as a first compartment size parameter 210 and/or a second compartment size parameter 211, a third structural parameter, such as a first ballast water level parameter 212 and/or a second ballast water level parameter 213, and/or a fourth structural parameter, such as a first compartment wall parameter 214 and/or a second compartment wall parameter 215.

The compartment number parameter 204 is indicative of the number of compartments in the first ballast tank.

The first compartment size parameter 210 is indicative of size of a first compartment of the first ballast tank. The second compartment size parameter 211 is indicative of size of a second compartment of the first ballast tank. The structural parameters 202 may comprise a plurality of compartment size parameters, including the first compartment size parameter 210 and the second compartment size parameter 211. The plurality of compartment size parameters is indicative of sizes of respective plurality of compartments of the first ballast tank.

The first ballast water level parameter 212 is indicative of a first ballast water level in the first ballast tank. The second ballast water level parameter 213 is indicative of a second ballast water level in the first ballast tank. The structural parameters 202 may comprise a plurality of ballast water level parameters, including the first ballast water level parameter 212 and the second ballast water level parameter 213. The plurality of ballast water level parameters is indicative of respective ballast water levels in the first ballast tank.

A compartment wall between adjacent compartments may have an area of opening of less than 50%, such as less than 30% such as less than 20%, such as less than 10%, such as less than 5%, relative to a compartment wall area completely sealing the adjacent compartments.

The first compartment wall parameter 214 is indicative of the area of compartment wall openings between a first compartment and a second compartment. The second compartment wall parameter 215 is indicative of the area of compartment wall openings between the second compartment and a third compartment. The structural parameters 202 may comprise one or more compartment wall parameters including the first compartment wall parameter 214 and/or the second compartment wall parameter 215. The one or more compartment wall parameters are indicative of the area of compartment wall openings between adjacent compartments.

The control data 206 is determined based on the structural parameters 202, such as one or more of the structural parameters 202, such as based on the compartment number parameter 204 and/or the first compartment size parameter 210 and/or the second compartment size parameter 211 and/or the first ballast water level parameter 212 and/or the second ballast water level parameter 213 and/or the first compartment wall parameter 214 and/or the second compartment wall parameter 215.

The control data 206 may be determined based on solving, such as numerically solving, a set of differential equations based on the structural parameters 202.

The control data 206 comprises a first volume parameter 208. The first volume parameter 208 is indicative of a first ballast water volume to be circulated, e.g. when the ballast water level is as indicated by the first ballast water level parameter 212. The control data 206 optionally comprises a second volume parameter 216. The second volume parameter 216 may be indicative of a second ballast water volume to be circulated, e.g. when the ballast water level is as indicated by the second ballast water level parameter 213. The first volume parameter and/or the second volume parameter may be expressed in absolute measures, e.g. liter, kg, m³, or it may be expressed relative to the volume of ballast water in the first ballast tank, e.g. a multiplication factor, such as a multiplication factor between 1 and 10.

The control data 206 may comprise a plurality of volume parameters, e.g. including the first volume parameter 208 and the second volume parameter 216. The plurality of volume parameters may constitute volume parameters indicative of a ballast water volume to be circulated in different situations, e.g. dependent on combinations of ballast water level, initial concentration of living microorganisms in the ballast water, and/or reduction parameter.

The control data 206 may be provided to a ballast water treatment system, e.g. via an interface, such as a user interface, and/or an usb interface, and/or a network interface. The control data 206 may be used to operate the ballast water treatment system according to the control data 206, such as according to the first volume parameter 208 and/or the second volume parameter 216.

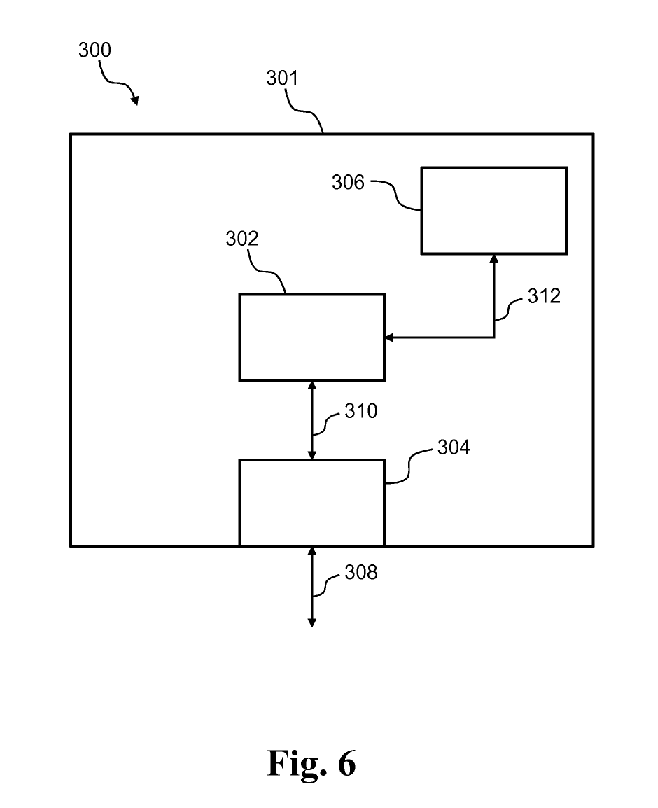

FIG. 6 schematically illustrates an exemplary configuration system 300. The configuration system 300 is configured for configuring a ballast water treatment system for treating ballast water of one or more ballast tanks in a vessel, wherein the ballast water treatment system is configured to circulate ballast water between a tank outlet and a tank inlet of a first ballast tank.

The configuration system 300 comprises a processing unit 302, an interface 304, and a memory unit 306. The configuration system 300 is furthermore shown comprising an optional housing 301.

The processing unit 302 is configured to communicate 310 with the interface 304. The processing unit 302 is configured to communicate 312 with the memory unit 306.

The interface 304 is configured to communicate 308 with external devices or operators. For example, the interface 304 may comprise a USB port, a network interface, a user interface etc.

The processing unit 302 is configured to obtain structural parameters of the first ballast tank, determine control data for the ballast water treatment system based on the structural parameters, and provide the control data. The processing unit 302 may comprise a determinator as the determinator 200 as described in relation to FIG. 5.

The processing unit 302 may obtain the structural parameters or one or more of the structural parameters from an operator via the interface 304. For example, an operator provides the structural parameters or one or more of the structural parameters by entering information via a user interface of the interface 304, and the processing unit 302 may obtain the structural parameters or one or more of the structural parameters from the interface 304.

Alternatively or additionally, the processing unit 302 may obtain the structural parameters or one or more of the structural parameters from the memory unit 306. For example, structural parameters may have been stored by the processing unit 302 in the memory unit 306, and the processing unit 302 may later obtain the structural parameters or one or more of the structural parameters from the memory unit 306.

The processing unit 302 may determine the control data as described for the determiniator 200 as described in relation to FIG. 5.

The processing unit 302 may provide the control data or part of the control data to an operator or an external device, e.g. to a ballast water treatment system, such as to a control unit of the ballast water treatment system. The processing unit 302 may provide the control data or part of the control data to the interface 304, e.g. the processing unit 302 may provide the control data or part of the control data to an operator or an external device via the interface 304.

Alternatively or additionally, the processing unit 302 may provide the control data or part of the control data to the memory unit 306. Furthermore, the processing unit 302 may be able to retrieve control data from the memory unit 306, and optionally provide the retrieved control data to the interface 304.

In the above description and examples, amounts are described as volumes. However, it is to be understood that amounts described as volumes may just as well be expressed as masses. In some applications it may be beneficial to measure mass rather than volume and vice versa. Thus, throughout the description and claims the word ‘volume’ may be exchanged with ‘mass’, and/or masses may be used indicative of volumes.

Although particular features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense.

The claimed invention is intended to cover all alternatives, modifications and equivalents.

### LIST OF REFERENCES

1 ballast water system
2 ballast water treatment system
4 ballast water
5 ballast water level
6 ballast tank
7A first compartment C₁
7B second compartment C₂
7C third compartment C₃
7D fourth compartment C₄
7E fifth compartment C₅
7F sixth compartment C₆
8 control unit
9A first compartment wall
9B second compartment wall
9C third compartment wall
9D fourth compartment wall
9E fifth compartment wall
10 pipe structure
12 first system inlet
14 first system outlet
16 tank outlet
18 tank inlet
20 pump unit
28 water treatment unit
42 pump control signal
100 method for configuring a ballast water treatment system
100′ method for controlling a ballast water treatment system
102 obtaining structural parameters
104 determining control data
106 providing control data
108 controlling the ballast water system
200 determiniator
202 structural parameters
204 compartment number parameter
206 control data
208 first volume parameter
210 first compartment size parameter
211 second compartment size parameter
212 first ballast water level parameter
213 second ballast water level parameter
214 first compartment wall parameter
215 second compartment wall parameter
216 second volume parameter
300 configuration system
301 housing
302 processing unit
304 interface
306 memory unit
308 interface communication
310 interface—processing unit communication
312 memory unit—processing unit communication

1. A method for configuring a ballast water treatment system for treating ballast water of one or more ballast tanks in a vessel, wherein the ballast water treatment system is configured to circulate ballast water between a tank outlet and a tank inlet of a first ballast tank, the method comprising:
obtaining structural parameters of the first ballast tank, wherein the structural parameters comprise a compartment number parameter indicative of a number of compartments in the first ballast tank;
determining control data for the ballast water treatment system based on the structural parameters, wherein the control data comprises a first volume parameter indicative of a first ballast water volume to be circulated; and
providing the control data to the ballast water treatment system.

2. Method according to claim 1, wherein the structural parameters comprise a first compartment size parameter indicative of size of a first compartment of the first ballast tank.

3. Method according to claim 1, wherein the structural parameters comprise a first ballast water level parameter indicative of a first ballast water level in the first ballast tank.

4. Method according to claim 1, wherein the structural parameters comprise one or more compartment wall parameters indicative of the area of compartment wall openings between adjacent compartments.

5. Method according to claim 1, wherein the first volume parameter is a multiplication factor of volume of ballast water in the first ballast tank.

6. Method according to claim 1, wherein the method further comprises obtaining a reduction parameter indicative of a desired reduction of concentration of living microorganisms in the ballast water, and wherein determining control data is based on the reduction parameter.

7. Method according to claim 6, wherein obtaining the reduction parameter comprises obtaining concentration of living microorganisms in the ballast water in the first ballast tank.

8. Method according to claim 1, wherein determining control data comprises solving a set of differential equations based on the structural parameters.

9. Method according to claim 8, wherein the set of differential equations models the change in concentration of living microorganisms in ballast tank compartments.

10. Method according to claim 8, wherein the set of differential equations is given by:
$$\frac{{dx}_{i}}{d Φ} = ( {x}_{i - 1} - {x}_{i} ) for i = 1 , … , M$$
where
$${x}_{i} = \frac{{c}_{i}}{{c}_{i , t = 0}} ,$$
where cᵢ is the concentration of living microorganisms in compartment Cᵢ, c_{i,t=0} is the concentration of living microorganisms in compartment Cᵢ at time t=0,
$${x}_{0} = \frac{{c}_{0}}{{c}_{0 , t = 0}} ,$$
where c₀ is the concentration of living microorganisms in ballast water entering through the tank inlet, c_{0,t=0} is the concentration of living microorganisms in ballast water entering through the tank inlet at time t=0,
$$Φ = \frac{{v}_{l} t}{{V}_{i}} ,$$
where vᵢ is the flow rate of ballast water through the tank, t is the time, and Vᵢ is the volume of ballast water in compartment Cᵢ, and M is the number of compartments.

11. Method according to claim 10, wherein xᵢ=1 for t=0.

12. Method according to claim 1, wherein the control data comprises a second volume parameter indicative of a second ballast water volume to be circulated, wherein the first ballast water volume is ballast water volume to be circulated at a first ballast water level, and wherein the second ballast water volume is ballast water volume to be circulated at a second ballast water level.

13. A configuration system for configuring a ballast water treatment system for treating ballast water of one or more ballast tanks in a vessel, wherein the ballast water treatment system is configured to circulate ballast water between a tank outlet and a tank inlet of a first ballast tank, the configuration system comprising a processing unit, an interface and a memory unit, wherein the processing unit is configured to:
obtain structural parameters of the first ballast tank, wherein the structural parameter comprise a compartment number parameter indicative of a number of compartments in the first ballast tank;
determine control data for the ballast water treatment system based on the structural parameters, wherein the control data comprises a first volume parameter indicative of a first ballast water volume to be circulated; and
provide the control data.
